(19) United States
(12) Patent Application Publication
(10) Pub. No.: US 2024/0305121 A1
(43) Pub. Date: Sep. 12, 2024

(54) POWER LOSS PROTECTION INTEGRATED CIRCUIT

(71) Applicant: FADU Inc., Seoul (KR)

(72) Inventors: Jinup LIM, Seoul (KR); Jungeui PARK, Suwon-si (KR); Jaeil LEE, Gwangmyeong-si (KR); Kwanseok JUNG, Seoul (KR)

(73) Assignee: FADU Inc., Seoul (KR)

(21) Appl. No.: 18/406,683

(22) Filed: Jan. 8, 2024

Related U.S. Application Data
(60) Provisional application No. 63/450,432, filed on Mar. 7, 2023.

(30) Foreign Application Priority Data
Mar. 7, 2023 (KR) 10-2023-0029756

(51) Int. Cl. H02J 7/00; H02J 7/34; H02J 9/06

(52) U.S. Cl. CPC H02J 7/00714; H02J 7/0013; H02J 7/00304; H02J 7/0048; H02J 7/005; H02J 7/345; H02J 9/06; H02J 2207/50

(57) ABSTRACT

A power loss protection integrated circuit is disclosed. The power loss protection integrated circuit includes separate charge/discharge paths to a plurality of storage capacitors to enable sequential checking of the plurality of storage capacitors for short failure. When any one of the storage capacitors has a short failure, charging of the corresponding storage capacitor is stopped. The plurality of storage capacitors are sequentially checked for deterioration after charge.

### CROSS REFERENCE TO RELATED APPLICATIONS

This application claims the benefit under 35 USC 119 (e) of U.S. Provisional Application No. 63/450,432 filed on Mar. 7, 2023, and claims the benefit under 35 USC 119 (a) and 365 (b) of Korean Patent Application No. 10-2023-0029756, filed on Mar. 7, 2023, in the Korean Intellectual Property Office, the entire disclosure of which is incorporated herein by reference for all purposes.

### BACKGROUND OF THE INVENTION

### 1. Field of the Invention

The present invention relates to a power loss protection integrated circuit, and more specifically to a power loss protection integrated circuit that stores energy in a plurality of storage capacitors in a normal power supply state and utilizes the energy charged in the capacitors to supply emergency power to a main system when the power supply is cut off wherein the capacitors are checked for short failure during charge and storage capacity after charge.

### 2. Description of the Related Art

In general, a memory system including memory devices and a memory controller operates when power is supplied from the outside. Thus, data being processed may be lost when the power supply to the memory system is unintentionally cut off. In order to cope with such an emergency situation, the memory system includes an auxiliary power supply that stores energy in a storage capacitor when power is normally supplied to the memory system, immediately detects a situation in which the power supply is cut off, and uses the energy pre-charged in the capacitor to supply emergency power. A power loss protection (integrated) circuit is used to store emergency power in the storage capacitor and supply the emergency power to the memory system.

The power loss protection circuit detects a short failure of the storage capacitor. Short failure refers to a type of failure in which damage to an internal insulator of a storage capacitor leads to conduction between two electrodes of the capacitor. The occurrence of a short failure is inspected at the time when charging is initiated. When an excessive charge current is detected during charging of the storage capacitor with a charge circuit, the storage capacitor is judged as having a short failure and its charging is stopped immediately.

The amount of energy required in an emergency power situation is proportional to the capacity of the storage capacitor and the performance (for example, maximum charge capacity) of the storage capacitor deteriorates depending on various factors such as operating voltage, temperature, humidity, and duration of use. Thus, the charge capacity of the storage capacitor needs to be inspected regularly. This regular inspection is called a “status check” or “health check” and is performed by the power loss protection circuit. Generally, the power loss protection circuit uses a discharge circuit for a predetermined time to discharge the storage capacitor. This discharge induces a voltage drop in the storage capacitor. The power loss protection circuit measures the dropped voltage or the time taken to reach the voltage drop to determine whether the charge capacity of the storage capacitor decreases.

As illustrated in FIG. 1, a conventional power loss protection circuit has a single charge/discharge path to a plurality of storage capacitors. When a short failure is detected in one of the plurality of storage capacitors during charge, the single charge/discharge path is blocked, making it impossible to use even the remaining normal storage capacitors as energy storage devices for emergency power supply. On the other hand, since health checks are performed during discharge, voltage drops are induced simultaneously in all storage capacitors under the single charge/discharge path. As a result, significant emergency power energy losses are inevitably caused. An emergency power situation occurs at the time when the voltage drops to the lowest level during the discharging process. In this case, since emergency power has no choice but to operate with reduced energy compared to the maximum stored energy, an additional storage capacitor is required to compensate for the expected energy reduction, which becomes a cause of the increased price and mounting area of products.

Thus, there is an urgent need for a solution to the problems of conventional power loss protection circuits.

### SUMMARY OF THE INVENTION

The present invention has been made in an effort to solve the problems of the prior art and an aspect of the present invention is to provide a power loss protection integrated circuit which includes separate charge/discharge paths to a plurality of storage capacitors to enable sequential checking of the plurality of storage capacitors for short failure wherein when any one of the storage capacitors has a short failure, charging of the corresponding storage capacitor is stopped and wherein the plurality of storage capacitors are sequentially checked for deterioration after charge.

A power loss protection integrated circuit according to an embodiment of the present invention is designed to charge N (N is a natural number greater than or equal to 2) storage capacitors and includes a charge circuit generating a charge current to charge the N storage capacitors, N separate electrical paths connected in a one-to-one relationship with the N storage capacitors and supplying the charge current to the N storage capacitors therethrough, N switches arranged in the corresponding electrical paths and turned ON/OFF to supply (ON) the charge current through the electrical paths or interrupt (OFF) the supply of the charge current, an overcurrent detection unit detecting whether the charge current supplied through the electrical paths is an overcurrent exceeding a predetermined critical current, and a control unit sequentially turning ON/OFF the N switches and immediately stopping charging the storage capacitor through a working path where the overcurrent is detected when the working path is defined as the electrical path where the switch in the ON state is arranged.

According to an exemplary embodiment of the present invention, the switches may be field effect transistor (FET) switches.

According to an exemplary embodiment of the present invention, the overcurrent detection unit may include a current comparator comparing the charge current and the critical current.

According to an exemplary embodiment of the present invention, the control unit may continuously turn OFF the switch arranged in the working path to block the working path when the overcurrent is detected.

According to an exemplary embodiment of the present invention, the power loss protection integrated circuit may include a discharge circuit generating a sink current to discharge the M (M is a natural number greater than or equal to 2) storage capacitors charged through some or all of the N electrical paths and a charge capacity measurement unit measuring voltage drops in the storage capacitors during discharge wherein the control unit may sequentially turn ON/OFF the switches arranged in the separate electrical paths connected to the M charged storage capacitors and measure the charge capacity of the storage capacitor discharged through the working path based on the voltage drop measured in the storage capacitor discharged through the working path.

According to an exemplary embodiment of the present invention, when the measured charge capacity of the storage capacitor discharged through the working path is lower than the predetermined critical capacity, the control unit may judge the storage capacitor as having a failure.

According to an exemplary embodiment of the present invention, when the discharged storage capacitor is judged as having a failure, the switch arranged in the working path may be continuously turned OFF to block the working path.

The features and advantages of the present invention will become apparent from the following description with reference to the accompanying drawings.

Prior to the detailed description of the invention, it should be understood that the terms and words used in the specification and the claims are not to be construed as having common and dictionary meanings but are construed as having meanings and concepts corresponding to the technical spirit of the present invention in view of the principle that the inventor can define properly the concept of the terms and words in order to describe his/her invention with the best method.

As described above, the power loss protection integrated circuit of the present invention includes separate charge/discharge paths to a plurality of storage capacitors. Therefore, when a short failure occurs in a specific one of the storage capacitors, only the charge/discharge path to the corresponding storage capacitor is blocked, enabling the use of the remaining normal storage capacitors for emergency power supply.

In addition, the storage capacitors corresponding to the separate charge/discharge paths are sequentially checked for charge capacity after charge. Therefore, voltage drops occurring in the charging process and the resulting energy losses can be divided and reduced.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an explanatory diagram illustrating the operation of a conventional power loss protection circuit using a single charge/discharge path;

FIG. 2 illustrates the configuration of a power loss protection integrated circuit according to one exemplary embodiment of the present invention;

FIG. 3 is an explanatory diagram illustrating the operation of the power loss protection circuit of FIG. 2;

FIG. 4 illustrates the configuration of a power loss protection integrated circuit according to another exemplary embodiment of the present invention; and

FIG. 5 is an explanatory diagram illustrating the operation of the power loss protection circuit of FIG. 4.

### DETAILED DESCRIPTION OF THE INVENTION

The objects, specific advantages, and novel features of the present invention will become apparent from the following detailed description and preferred embodiments in conjunction with the accompanying drawings. It should be noted that in the drawings, the same components are denoted by the same reference numerals even though they are depicted in different drawings. Although such terms as “first” and “second,” etc. may be used to describe various components, these components should not be limited by above terms. These terms are used only to distinguish one component from another. In the description of the present invention, detailed explanations of related art are omitted when it is deemed that they may unnecessarily obscure the essence of the present invention.

Preferred embodiments of the present invention will now be described in detail with reference to the accompanying drawings.

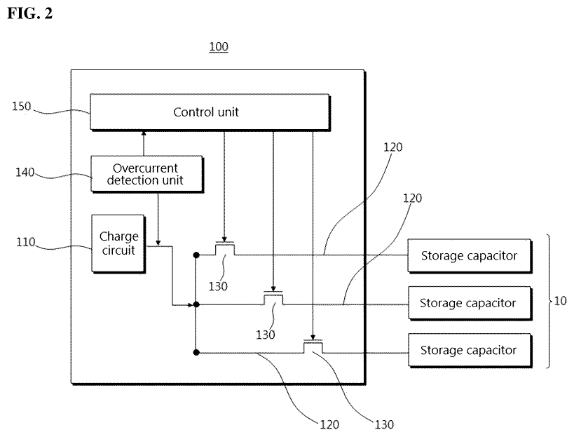

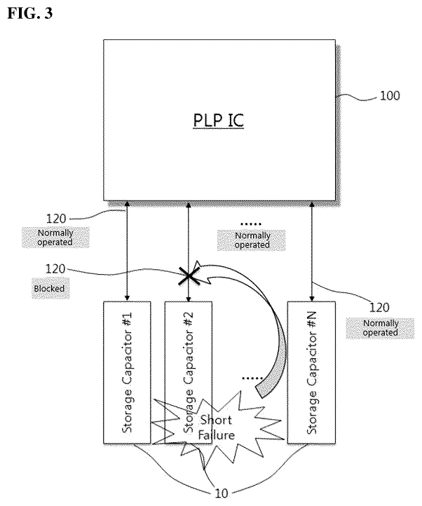

FIG. 2 illustrates the configuration of a power loss protection integrated circuit according to one exemplary embodiment of the present invention and FIG. 3 is an explanatory diagram illustrating the operation of the power loss protection circuit.

The power loss protection integrated circuit 100 illustrated in FIGS. 2 and 3 is designed to charge N (N is a natural number greater than or equal to 2) storage capacitors 10 and includes a charge circuit 110 generating a charge current to charge the N storage capacitors 10, N separate electrical paths 120 connected in a one-to-one relationship with the N storage capacitors 10 and supplying the charge current to the N storage capacitors 10 therethrough, N switches 130 arranged in the corresponding electrical paths 120 and turned ON/OFF to supply (ON) the charge current through the electrical paths 120 or interrupt (OFF) the supply of the charge current, an overcurrent detection unit 140 detecting whether the charge current supplied through the electrical paths 120 is an overcurrent exceeding a predetermined critical current, and a control unit 150 sequentially turning ON/OFF the N switches 130 and immediately stopping charging the storage capacitor through a working path where the overcurrent is detected when the working path is defined as the electrical path where the switch 130 in the ON state is arranged.

The power loss protection integrated circuit 100 stores energy in the storage capacitors 10 in a normal power supply state and utilizes the energy charged in the capacitors 10 to supply emergency power to a main system when the power supply is unintentionally cut off. The main system is an assembly of devices that receives power from the power loss protection integrated circuit 100 and performs a predetermined function. As an example, the main system may be a solid state drive (SSD) or may consist of elements in the SSD. An SSD is a semiconductor-based storage device and may include a power loss protection integrated circuit that can supply emergency power to prevent data being processed from being lost even in an unintentional sudden power cut off situation. In this case, the power loss protection integrated circuit supplies power to a power management device such as a PMIC in an SSD and supports such that data are stably stored in a NAND flash memory.

The power loss protection integrated circuit 100 detects a short failure of each of the storage capacitors 10. Short failure refers to a type of failure in which damage to an internal insulator of a storage capacitor leads to conduction between two electrodes of the capacitor. The occurrence of a short failure is inspected at the time when charging is initiated.

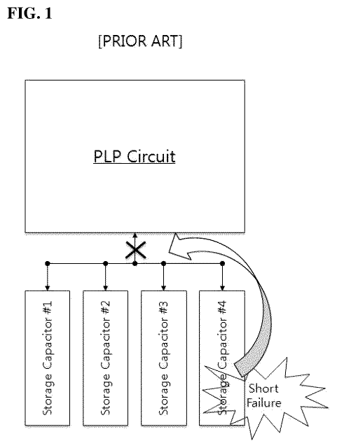

As illustrated in FIG. 1, a conventional power loss protection circuit has a single charge/discharge path to a plurality of storage capacitors. When a short failure is detected in one of the plurality of storage capacitors during charge, the single charge/discharge path is blocked, making it impossible to use even the remaining normal storage capacitors as energy storage devices for emergency power supply. The present invention has been devised to provide a solution to this problem.

Specifically, the power loss protection integrated circuit 100 charges storage capacitors 10 and detects a short failure of each of the storage capacitors 10 during charging of the storage capacitor 10. To cope with such a short failure, the power loss protection integrated circuit 100 includes a charge circuit 110, electrical paths 120, switches 130, an overcurrent detection unit 140, and a control unit 150, as described above.

The charge circuit 110 serves to charge the storage capacitors 10 for energy storage in a normal power situation to prepare for an emergency power situation. The number of the storage capacitors 10 is N (N is a natural number greater than or equal to 2). The storage capacitors 10 are charged by the charge circuit 110. The charge circuit 110 generates a charge current to charge the storage capacitors 10. The storage capacitors 10 are charged by the generated charge current. The charge circuit 110 operates in a state where power is normally supplied by an external power source. At this time, the charge circuit 110 uses the power input from the external power source to charge the storage capacitors 10. The charge circuit 110 may be implemented by various devices such as converters and switches.

The electrical paths 120 are electrical passages through which the charge current generated by the charge circuit 110 is supplied to the storage capacitors 10. The electrical paths 120 are provided in N. The N electrical paths 120 are separated from each other and are electrically connected in a one-to-one relationship with the N storage capacitors 10. Since the N electrical paths 120 are electrically connected to the charge circuit 110, each of the electrical paths 120 is used to charge the corresponding storage capacitor 10. That is, the N separate electrical paths 120 act as charge paths. The N electrical paths 120 are used to charge the N storage capacitors 10 sequentially and independently rather than simultaneously.

The electrical paths 120 may be embodied as conductive members. For example, each of the electrical paths 120 may be a wire, a terminal to which a wire is electrically fastened, or a combination thereof. The electrical paths 120 may be of any shape as long as they permit the supply of the charge current generated by the charge circuit 110 to the storage capacitors 10 therethrough.

The switches 130 are devices that connect or disconnect the electrical paths 120 through ON/OFF operation. The switches 130 are provided in N and are arranged one-to-one corresponding to the N electrical paths 120. The switch 130 in the ON state supplies the charge current to the corresponding storage capacitor 10 through the corresponding electrical path 120. Meanwhile, the switch 130 is turned OFF to interrupt the supply of the charge current through the corresponding electrical path 120. The switches 130 are implemented by field effect transistors (FETs) whose ON/OFF operation can be controlled by electrical signals. However, the switches 130 are not necessarily limited to field effect transistors.

The overcurrent detection unit 140 serves to detect whether the charge current is an overcurrent exceeding a predetermined critical current. The charge current is supplied through the N electrical paths 120. At this time, the overcurrent detection unit 140 detects whether the charge current is excessive. The critical current refers to a reference current value that can be used to determine which one of the storage capacitors 10 has a short failure. The occurrence of a short failure in one of the storage capacitors 10 leads to an excessive increase in the magnitude of the charge current supplied to the storage capacitor. Accordingly, when the charge current supplied to one of the storage capacitors 10 is greater than the critical current, it can be determined that a short failure has occurred in the corresponding storage capacitor 10.

The overcurrent detection unit 140 may include a current comparator. The current comparator compares the charge current and the critical current and determines which of the charge current and the critical current is larger.

The control unit 150 controls the ON/OFF operation of the N switches 130. At the time when charging of the storage capacitors 10 is initiated, the control unit 150 sequentially turns ON/OFF the N switches 130. Thus, when the electrical path 120 in which the switch 130 in the ON state is arranged is referred to as a working path, the charge current is supplied only through the working path, with the result that only one storage capacitor 10 connected with the working path is charged and the other storage capacitors 10 are not charged. For example, as illustrated in FIG. 3, the first electrical path 120, which is turned ON/OFF by the first switch 130, is electrically connected to the first storage capacitor 10, the second electrical path 120, which is turned ON/OFF by the second switch 130, is electrically connected to the second storage capacitor 10, . . . , and the N^{th} electrical path 120, which is turned ON/OFF by the N^{th} storage capacitor 10, is electrically connected to the N^{th} storage capacitor 10. In this case, the control unit 150 sequentially turns ON/OFF the first to N^{th} switches 130, enabling sequential and independent charging of the first to N^{th} storage capacitors 10, and the overcurrent detection unit 140 detects an overcurrent in the electrical paths 120 (including the working path) through which the charge current is sequentially supplied. For example, when the overcurrent detection unit 140 detects an overcurrent in the second electrical path 120 as the working path, the control unit 150 determines that the second storage capacitor 10 connected with the corresponding working path has a short failure, immediately stops the charging through the working path, and charges another one of the storage capacitors 10 through the corresponding electrical path 120. When an overcurrent is detected, the control unit 150 continuously turns OFF the switch 130 arranged in the working path to block the working path, enabling selective stopping of charging of the storage capacitor 10 where a short failure occurred.

That is, in the power loss protection integrated circuit 100, the separate electrical paths 120 are connected to the corresponding N storage capacitors 10 and the switches 130 are sequentially operated at the time of initiation of charging to sequentially and independently charge the N storage capacitors 10. When a short failure is detected in one of the storage capacitors 10 during the charging process, the power loss protection integrated circuit 100 blocks only the electrical path (charge path) corresponding to the storage capacitor 10, enabling the use of the remaining storage capacitors 10 for emergency power supply.

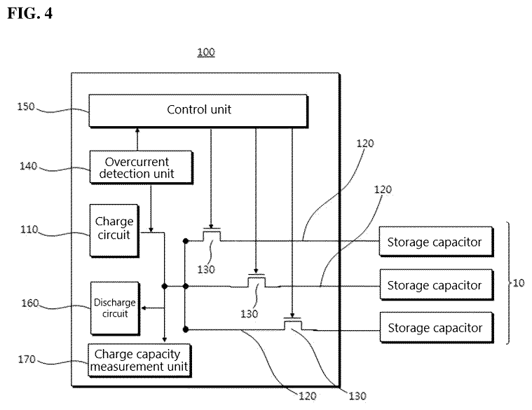

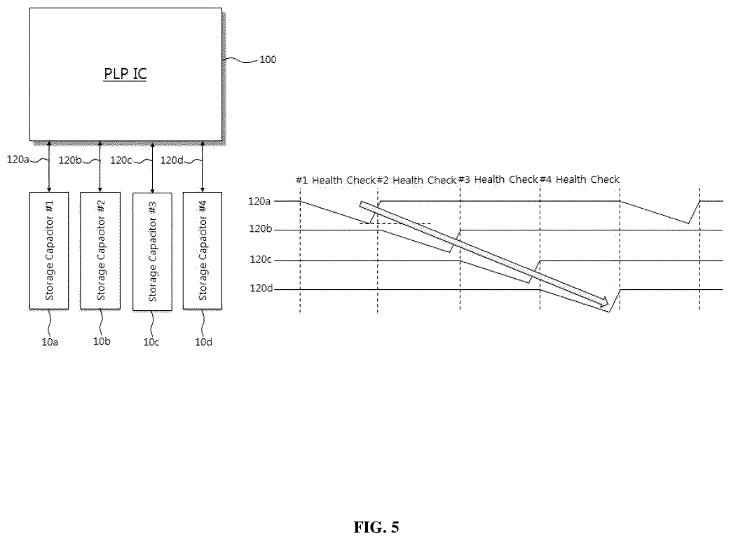

FIG. 4 illustrates the configuration of a power loss protection integrated circuit according to another exemplary embodiment of the present invention and FIG. 5 is an explanatory diagram illustrating the operation of the power loss protection circuit of FIG. 4.

After charging of the M storage capacitors 10 is completed, the charge capacities of the storage capacitors 10 decrease depending on the operating environment. Thus, the power loss protection integrated circuit 100 regularly inspects the charge capacities of the M storage capacitors 10 after charge. This regular inspection is called a “status check” or “health check”.

The conventional power loss protection circuit illustrated in FIG. 1, which uses a single charge/discharge circuit, intentionally discharges the storage capacitors during the health check process. As a result, voltage drops occur in all storage capacitors, inevitably leading to energy loss. Further, an emergency power situation occurs at the time when the voltage drops to the lowest level during the discharging process. In this case, since emergency power has no choice but to operate with reduced energy compared to the maximum stored energy, an additional storage capacitor is required to compensate for the expected energy reduction, which becomes a cause of the increased price and mounting area of products. The power loss protection integrated circuit 100 illustrated in FIG. 4 has been devised to provide a solution to the problems of the conventional power loss protection integrated circuit.

As illustrated in FIG. 4, the power loss protection integrated circuit 100 includes a charge circuit 110, electrical paths 120, switches 130, an overcurrent detection unit 140, and a control unit 150, which are the same those described in the previous embodiment. The power loss protection integrated circuit 100 may further include a discharge circuit 160 and a charge capacity measurement unit 170. The charge circuit 110 and the overcurrent detection unit 140 may not operate during health check.

The discharge circuit 160 is a circuit that discharges M (M is a natural number greater than or equal to 2) storage capacitors 10, which are charged through the same charging process as described in the previous embodiment. Here, the number (M) of storage capacitors is determined by subtracting the number (K) (K is a natural number greater than or equal to 1) of storage capacitors 10 with short failure from the initial number (N) of storage capacitors (i.e. M=N−K). Accordingly, when no short failure occurs, the discharge circuit discharges the N storage capacitors 10 to perform health checks.

The N electrical paths 120 are separated from each other. Some or all of the N separate electrical paths 120 are used to independently perform health checks on the M storage capacitors 10. The electrical paths 120 connected to the storage capacitors 10 where no short failure occurs are used for health checks. Accordingly, health checks are independently performed on the M storage capacitors 10 through the M electrical paths 120 (corresponding to some or all of the N electrical paths).

The discharge circuit 160 serves to generate a sink current for health checks. The sink current independently discharges the storage capacitors 10 through the corresponding M electrical paths 120. Such intentional discharging of the storage capacitors 10 causes voltage drops in the storage capacitors 10 for predetermined periods of time.

The charge capacity measurement unit 170 serves to measure voltage drops in the storage capacitors 10 during discharge. Since the M storage capacitors 10 are discharged independently, the charge capacity measurement unit 170 measures voltage drops in the M storage capacitors 10 being discharged.

The control unit 150 sequentially turns ON/OFF the switches 130 arranged in the corresponding M electrical paths 120 connected in a one-to-one relationship with the M charged capacitors 10 during the health check process as well as during the charging process. The order in which the switches 130 are turned ON/OFF during the charging process does not necessarily have to match that during the health check process. That is, although the first to N^{th} switches 130 are turned ON/OFF in this order during the charging process, the ON/OFF operation may be performed in the reverse order or randomly during the health check process.

When the switches 130 arranged in the corresponding M electrical paths 120 are sequentially turned ON/OFF, discharge occurs only through a working path and the charge capacity measurement unit 170 measures a voltage drop in the storage capacitor 10 where discharge occurs through the working path. The working path is defined as the electrical path 120 where the switch 130 in the ON state is arranged.

The control unit 150 may measure the charge capacity of the storage capacitor 10 discharged through the working path based on the voltage drop measured in the storage capacitor 10. As the capacitance of the storage capacitor 10 decreases, a larger voltage drop occurs for the same period of time or a shorter time is taken to reach the same voltage drop. Thus, the charge capacity of the capacitor 10 can be measured by determining the voltage drop or the time required to reach the voltage drop. However, there is no restriction on how to measure the charge capacity of the storage capacitor 10. The control unit 150 compares the measured charge capacity of the storage capacitor 10 with a predetermined critical capacity. When the charge capacity is lower than the critical capacity, the storage capacitor 10 discharged through the working path is judged as having a failure. In this case, the switch 130 arranged in the working path is continuously turned OFF to block the working path, thereby limiting the use of the storage capacitor 10.

Referring to FIG. 5, health checks are performed sequentially on the separate electrical paths (discharge paths) 120. Therefore, voltage drops occurring in the health check process and the resulting energy losses can be divided and reduced. For example, in the case where first to fourth health checks are performed sequentially and independently through the first 120a to fourth discharge paths 120d corresponding one-to-one with the first 10a to fourth storage capacitors 10d, only the first storage capacitor 10 is discharged and the second to fourth storage capacitors 10 are not discharged for the first health check time. Also in the case where second to fourth health checks are performed continuously, only the second to fourth storage capacitors 10 are discharged during the corresponding health checks. In a conventional power loss protection circuit using a single discharge path, energy losses occur simultaneously in all of the first to fourth storage capacitors during the health check process. In contrast, the power loss protection circuit of the present invention, which uses separate discharge paths 120a to 120d, causes energy losses corresponding to one-fourth of those in the conventional power loss protection circuit.

Health checks are sequentially and independently performed on the M charged storage capacitors 10, as described above, but the order of health checks on the M storage capacitors 10 is not necessarily specified. For example, health checks may be performed in the order of the first to M^{th} storage capacitors and this order may be maintained every health check cycle. In contrast, health checks may be performed independently according to the same or different health check cycles determined for the M storage capacitors 10. Referring to FIG. 5, first to fourth health checks are performed independently through the first 120a to fourth discharge paths 120d, and then i) after a predetermined health check cycle, the first to fourth health checks may again be performed in the order of the first 120a to fourth discharge paths 120d or ii) after the fourth health check through the fourth discharge path 120d, the first to third health checks may be performed in the order of the first 120a to third discharge paths 120c. In conclusion, as long as health checks are not performed simultaneously on at least two of the M storage capacitors 10 and are performed on the storage capacitors 10 one by one, different health check cycles may be run on the M storage capacitors 10.

Overall, the power loss protection integrated circuit of the present invention includes separate charge/discharge paths to a plurality of storage capacitors. Therefore, when a short failure occurs in a specific one of the storage capacitors, only the charge/discharge path to the corresponding storage capacitor is blocked, enabling the use of the remaining normal storage capacitors for emergency power supply. In addition, the storage capacitors corresponding to the separate charge/discharge paths are sequentially checked for charge capacity after charge. Therefore, voltage drops occurring in the charging process and the resulting energy losses can be divided and reduced.

Although the present invention has been described herein with reference to the foregoing specific embodiments, these embodiments do not serve to limit the invention and are set forth for illustrative purposes. It will be apparent to those skilled in the art that modifications and improvements can be made without departing from the spirit and scope of the invention.

Simple modifications and changes of the present invention belong to the scope of the present invention and the specific scope of the present invention will be clearly defined by the appended claims.

What is claimed is:

1. A power loss protection integrated circuit for charging N (N is a natural number greater than or equal to 2) storage capacitors, comprising: a charge circuit generating a charge current to charge the N storage capacitors; N separate electrical paths connected in a one-to-one relationship with the N storage capacitors and supplying the charge current to the N storage capacitors therethrough; N switches arranged in the corresponding electrical paths and turned ON/OFF to supply (ON) the charge current through the electrical paths or interrupt (OFF) the supply of the charge current; an overcurrent detection unit detecting whether the charge current supplied through the electrical paths is an overcurrent exceeding a predetermined critical current; and a control unit sequentially turning ON/OFF the N switches and immediately stopping charging the storage capacitor through a working path where the overcurrent is detected when the working path is defined as the electrical path where the switch in the ON state is arranged.

2. The power loss protection integrated circuit according to claim 1, wherein the switches are field effect transistor (FET) switches.

3. The power loss protection integrated circuit according to claim 1, wherein the overcurrent detection unit comprises a current comparator comparing the charge current and the critical current.

4. The power loss protection integrated circuit according to claim 1, wherein the control unit continuously turns OFF the switch arranged in the working path to block the working path when the overcurrent is detected.

5. The power loss protection integrated circuit according to claim 1, wherein the power loss protection integrated circuit comprises a discharge circuit generating a sink current to discharge the M (M is a natural number greater than or equal to 2) storage capacitors charged through some or all of the N electrical paths and a charge capacity measurement unit measuring voltage drops in the storage capacitors during discharge wherein the control unit sequentially turns ON/OFF the switches arranged in the separate electrical paths connected to the M charged storage capacitors and measure the charge capacity of the storage capacitor discharged through the working path based on the voltage drop measured in the storage capacitor discharged through the working path.

6. The power loss protection integrated circuit according to claim 5, wherein when the measured charge capacity of the storage capacitor discharged through the working path is lower than the predetermined critical capacity, the control unit judges the storage capacitor as having a failure.

7. The power loss protection integrated circuit according to claim 6, wherein when the discharged storage capacitor is judged as having a failure, the switch arranged in the working path is continuously turned OFF to block the working path.
